(19) United States
(12) Patent Application Publication
(10) Pub. No.: US 2017/0323313 A1
(43) Pub. Date: Nov. 9, 2017

(54) INFORMATION PROPAGATION METHOD AND APPARATUS

(71) Applicant: Alibaba Group Holding Limited, Grand Cayman (KY)

(72) Inventors: Chao Li, Zhejiang (CN); Zhirong WANG, Zhejiang (CN)

(73) Assignee: Alibaba Group Holding Limited

(21) Appl. No.: 15/662,188

(22) Filed: Jul. 27, 2017

Related U.S. Application Data
(63) Continuation of application No. PCT/CN2016/072783, filed on Jan. 29, 2016.

(30) Foreign Application Priority Data
Feb. 4, 2015 (CN) 201510058167.8

(51) Int. Cl. G06Q 30/02; G06N 7/00; G06N 99/00; G06Q 50/00

(52) U.S. Cl. CPC G06Q 30/0201; G06N 99/005; G06N 7/005; G06Q 50/01

(57) ABSTRACT

An information propagation method includes: determining a first user corresponding to to-be-propagated information, the first user being a user whose influence is greater than a preset value in an interest type network to which the first user belongs; and acquiring a user relation network that takes the first user as a starting point, and propagating the information in the user relation network by taking the first user as a starting point. The method improves efficiency and credibility of information propagation.

### CROSS REFERENCE TO RELATED PATENT APPLICATIONS

This application claims priority to and is a continuation of PCT Patent Application No. PCT/CN2016/072783, filed on 29 Jan. 2016, which claims priority to Chinese Patent Application No. 201510058167.8, filed on 4 Feb. 2015, entitled “INFORMATION PROPAGATION METHOD AND APPARATUS,” which are hereby incorporated by reference in their entirety.

### TECHNICAL FIELD

The present disclosure relates to the field of Internet technologies and, in particular, to an information propagation method and apparatus.

### BACKGROUND

With the development of the information society, lots of information need to be propagated effectively. In recent years, social networks have become main channels of acquiring and sharing information by people. Propagating information through a social network, such as through information sharing between users, is more easily accepted by users. As information propagation in the social network is still in a preliminary stage, lots of information propagation factors (for example, an information propagation speed, an information propagation range and other parameters) are still in a state of being difficult to predict. At present, during information propagation, a special propagation manner such as advertising or marketing promotion can be adopted, but such a propagation manner is not easily accepted by users, and is inefficient.

In conventional techniques, information propagation may be controlled by establishing a probability model to learn an information propagation probability between users. In a process of propagation probability learning, an Expectation-maximization (EM) model may be utilized to learn a propagation probability between users. However, as sparseness of data results in non-uniform data distribution, an extreme probability situation where the probability is 0 or 1 is easily obtained through calculating with an EM model method. As a result, an obtained propagation probability often has a relatively great variance, and the propagation efficiency obtained from an actual application is still not high.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

In the conventional Internet technologies, data at different websites are separate and isolated. For example, e-commerce platforms, such as Amazon™ or Ebay™, focus on collecting data of user purchase behavior of individual users. At the meantime, such individual users may be part of a social network, such as Facebook™ or Linkedin™ However, these two types of websites, e-commerce website and social network website, are not integrated and their data are not stored in the same database or data table for easy analysis, which present a unique technical challenge to Internet era that how to propagate information based on data collected from one type of website such as e-commerce website to another type of website such as the social network website. The present techniques of the present disclosure use data mining techniques to find similarities among users and commodities and identify a first user whose influence is higher than a preset value in a particular interest type network, such as fashion, outdoors, based on user behaviors relating to commodities in the particular interest type network. The present techniques then find the social network of the first user based on corresponding identification (ID) of the first user in a pre-established social network, such as friends of the first user on Facebook™ or Twitter™. The present techniques may use the existing social network, or create a new social network by extracting contacts of the first user in various existing social networks. The present techniques propagate information, which may relate to the particular interest type network, in the social network by using the first user as a starting point. For example, in a distributed computing environment, web crawlers are used to crawl social contacts of the first user on different social websites to form the social network of the first user and the information are propagated to different contacts of the first user on different social websites, which could be direct emails carrying the information to the contacts without triggering the existing social networks for transmission, or messages carrying the information to the contacts through the messaging functions provided by the existing social networks.

The present disclosure is aimed at least solving one of the technical problems in the related art to some extent.

The present disclosure provides an example method comprising:

collecting user behaviors of user identifications (IDs) associated with commodities, the user behaviors including recorded purchasing histories of the user IDs associated with the commodities;

calculating similarity degrees between commodities based on similarity degrees between attributes of the commodities;

calculating labels associated with the commodities;

associating the user IDs with the labels based on the user behaviors of the user IDs;

extracting multiple interest type networks from the labels;

determining a respective first user ID from a respective interest type network of the multiple interest type networks, the respective first user ID being a user ID whose influence is greater than a preset value in the respective interest type network to which the first user ID belongs based on user behaviors of the respective first user ID associated with respective commodities relating to the respective interest type network; and

establishing a respective user relation network by using the respective first user ID as a starting point and exploring a social network of the respective first user ID, the respective user relation network including one or more contacts of the respective user ID in the social network.

For example, the method further comprises:

determining information associated with the respective interest type network; and

propagating the information in the respective user relation network through the respective first user ID.

For example, the propagating the information in the respective user relation network through the respective first user ID includes:

propagating the information in the user relation network by using the respective first user ID as the starting point.

For example, the propagating the information in the user relation network by using the first user ID as the starting point includes:

propagating the information in the respective user relation network by using the first user ID as the starting point according to a propagation range strategy.

For example, the propagating the information in the user relation network by using the first user ID as the starting point includes:

propagating the information in the respective user relation network by using the first user ID as the starting point according to a propagation speed strategy.

For example, the propagating the information in the respective user relation network by using the first user ID as the starting point according to the propagation speed strategy includes:

acquiring a propagation probability between user IDs in the respective user relation network;

determining a path of which the propagation probability is greater than a preset value as a propagation path; and

propagating the information according to the propagation path.

For example, the acquiring the propagation probability between user IDs in the respective user relation network includes:

acquiring the propagation probability between the user IDs in the respective user relation network according to a propagation probability learning model into which a propagation probability variance control factor is introduced.

For example, the acquiring the propagation probability between the user IDs in the respective user relation network according to the propagation probability learning model into which the propagation probability variance control factor is introduced includes:

establishing an information propagation model according to the respective user relation network and time slice data, the time slice data being preset information propagation and spread time;

introducing the propagation probability variance control factor into the propagation probability learning model, to obtain the propagation probability learning model into which the propagation probability variance control factor is introduced; and

learning the information propagation model according to the propagation probability learning model into which the propagation probability variance control factor is introduced, to acquire a propagation probability updating rule.

For example, the method further comprises:

updating a propagation probability between a first group of user IDs by using a first updating rule included in the propagation probability updating rule, edges between the first group of user IDs being activated in the time slice data; and

determining the updated propagation probability between the user IDs as the propagation probability between the user IDs in the respective user relation network.

For example, the method further comprises:

updating a propagation probability between a second group of users by using a second updating rule included in the propagation probability updating rule, edges between the second group of users being not activated in the time slice data; and

determining the updated propagation probability between the user IDs as the propagation probability between the user IDs in the respective user relation network.

For example, the user behaviors of the user IDs associated with the commodities further include recorded online browsing, clicking, or collecting histories of the user IDs associated with the commodities.

For example, the collecting user behaviors of user IDs associated with commodities includes:

determining multiple user IDs as superior user IDs; and

choosing commodities associated with user behaviors of the superior user IDs.

For example, the determining multiple user IDs as superior user IDs includes:

selecting the superior user IDs from the multiple user IDs according to credit ratings or purchase frequencies associated with the multiple user IDs.

For example, the attributes of the commodities include:

the user behaviors of the user IDs of the commodities;

titles of the commodities; or

descriptions of the commodities.

The present disclosure also provides an apparatus comprising:

one or more processors; and

one or more memories stored thereon computer readable instructions that, when executed by one or more processors, cause the one or more processors to perform acts comprising:

calculating similarity degrees between commodities based on similarity degrees between attributes of the commodities;

calculating labels associated with the commodities;

associating the user IDs with the labels based on the user behaviors of the user IDs;

extracting multiple interest type networks from the labels; and

determining a respective first user ID from a respective interest type network of the multiple interest type networks, the respective first user ID being a user ID whose influence is greater than a preset value in the respective interest type network to which the first user ID belongs based on user behaviors of the respective first user ID associated with respective commodities relating to the respective interest type network.

For example, the acts further comprise:

establishing a respective user relation network by using the respective first user ID as a starting point and exploring a social network of the respective first user ID, the respective user relation network including one or more contacts of the respective user ID in the social network.

For example, the acts further comprise:

determining information associated with the respective interest type network; and

propagating the information in the respective user relation network through the respective first user ID.

For example, the propagating the information in the respective user relation network through the respective first user ID includes:

propagating the information in the user relation network by using the respective first user ID as a starting point.

The present disclosure also provides one or more memories stored thereon computer readable instructions that, when executed by one or more processors, cause the one or more processors to perform acts comprising:

determining a first user identification (ID) according to user behaviors associated with multiple user IDs on one or more shopping websites, the first user being a user whose influence is greater than a preset value in an interest type network to which the first user belongs; and

acquiring a user relation network according to one or more contacts of the first user ID in a social network.

For example, the acts further comprise:

determining information associated with the interest type network; and

propagating the information in the user relation network by using the first user ID as a starting point.

Further, one objective of the present disclosure is to provide an information propagation method. The method improves efficiency and credibility of information propagation.

Another objective of the present disclosure is to provide an information propagation apparatus.

In order to achieve the foregoing objective, the information propagation method according to example embodiments of the present disclosure includes: determining a first user corresponding to to-be-propagated information, the first user being a user whose influence is greater than a preset value in an interest type network to which the first user belongs; and acquiring a user relation network that takes the first user as a starting point, and propagating the information in the user relation network by taking the first user as a starting point.

The information propagation method, according to the example embodiments of the present disclosure, determines a first user corresponding to to-be-propagated information, the first user being a user whose influence is greater than a preset value, and propagates the information by taking the first user as the starting point. Thus, the information is propagated by the user having a greater influence, thereby improving credibility of information propagation and improving efficiency of the information propagation.

In order to achieve the foregoing objective, the information propagation apparatus according to the example embodiments of the present disclosure includes: a determination module configured to determine a first user corresponding to to-be-propagated information, the first user being a user whose influence is greater than a preset value in an interest type network to which the first user belongs; and a propagation module configured to acquire a user relation network that takes the first user as a starting point, and propagate the information in the user relation network by taking the first user as a starting point.

The information propagation apparatus according to the example embodiments of the present disclosure, determines a first user corresponding to to-be-propagated information, the first user being a user whose influence is greater than a preset value, and propagates the information by taking the first user as a starting point. Thus, the information is propagated by the user having a greater influence, thereby improving credibility of information propagation and improving efficiency of the information propagation.

Additional aspects and advantages of the present disclosure will be partially given in the following description, and some will become evident from the following description or will be understood through practice of the present disclosure.

### BRIEF DESCRIPTION OF THE DRAWINGS

The foregoing and/or additional aspects and advantages of the present disclosure will become evident and readily comprehensible from the following description of the example embodiments with reference to the accompanying drawings, wherein:

FIG. 1 is a schematic flowchart of an information propagation method according to an example embodiment of the present disclosure;

FIG. 2 is a schematic diagram of an interest type network according to an example embodiment of the present disclosure;

FIG. 3 is a schematic flowchart of establishing a preset number of interest type networks, and determining a corresponding first user in each interest type network according to an example embodiment of the present disclosure;

FIG. 4 is a schematic diagram of determining a first user corresponding to to-be-propagated information according to an example embodiment of the present disclosure;

FIG. 5 is a schematic diagram of a propagation probability of a user relation network according to an example embodiment of the present disclosure;

FIG. 6 is a schematic flowchart of acquiring a propagation probability between users according to an example embodiment of the present disclosure;

FIG. 7 is a schematic structural diagram of an information propagation apparatus according to another example embodiment of the present disclosure; and

FIG. 8 is a schematic structural diagram of an information propagation apparatus according to another example embodiment of the present disclosure.

### DETAILED DESCRIPTION

The example embodiments of the present disclosure are described in detail in the following. Examples of the example embodiments are illustrated in the accompanying drawings, wherein identical or similar symbols indicate identical or similar elements or elements having identical or similar functions throughout the text. The following example embodiments described with reference to the accompanying drawings are exemplary, and are merely intended to explain the present disclosure, but are not to be understood as limiting the present disclosure.

The present disclosure provides an information propagation method comprising:

determining a first user corresponding to to-be-propagated information, the first user being a user whose influence is greater than a preset value in an interest type network to which the first user belongs; and

acquiring a user relation network that takes the first user as a starting point, and propagating the information in the user relation network by taking the first user as the starting point.

For example, the method further comprises:

establishing a preset number of interest type networks, and determining a corresponding first user in each interest type network, the establishing the preset number of interest type networks and determining corresponding first user in each interest type network includes:

acquiring a user-label matrix according to a label propagation learning algorithm; and

clustering the user-label matrix to obtain the preset number of interest type networks and acquiring a first user in each interest type network.

For example, identity information of the first user includes user IDs and labels; the interest type network includes labels, and the determining the first user corresponding to the to-be-propagated information includes:

acquiring a first label, the first label being a label comprised in the to-be-propagated information; and

determining a first user comprising the first label as the first user corresponding to the to-be-propagated information.

For example, the propagating the information in the user relation network by taking the first user as a starting includes:

propagating, according to a preset strategy, the information in the user relation network by taking the first user as the starting point, the preset strategy including a propagation range strategy or a propagation speed strategy.

For example, when the preset strategy is the propagation speed strategy, the propagating, according to the preset strategy, the information in the user relation network by taking the first user as the starting point includes:

acquiring a propagation probability between users in the user relation network;

determining a path of which the propagation probability is greater than a preset value as a propagation path; and

propagating the information according to the propagation path.

For example, wherein the acquiring the propagation probability between users in the user relation network includes:

acquiring the propagation probability between users in the user relation network according to a propagation probability learning model into which a propagation probability variance control factor is introduced.

For example, wherein the acquiring the propagation probability between users in the user relation network according to the propagation probability learning model into which the propagation probability variance control factor is introduced includes:

acquiring the user relation network, and establishing an information propagation model according to the user relation network and time slice data, the time slice data being preset information propagation and spread time;

introducing the propagation probability variance control factor into the propagation probability learning model, to obtain the propagation probability learning model into which the propagation probability variance control factor is introduced, and learning the information propagation model according to the propagation probability learning model into which the propagation probability variance control factor is introduced, to acquire a propagation probability updating rule, the updating rule including a first updating rule and a second updating rule;

updating a propagation probability between a first group of users by using the first updating rule, and updating a propagation probability between a second group of users by using the second updating rule, edges between the first group of users being activated in the time slice data, and edges between the second group of users being not activated in the time slice data; and

determining the updated propagation probability between the users as the propagation probability between the users in the user relation network.

The present disclosure also provides an information propagation apparatus comprising:

a determination module configured to determine a first user corresponding to to-be-propagated information, the first user being a user whose influence is greater than a preset value in an interest type network to which the first user belongs; and

a propagation module configured to acquire a user relation network that takes the first user as a starting point, and propagate the information in the user relation network by taking the first user as a starting point.

For example, the information propagation apparatus further comprises:

an establishment module configured to establish a preset number of interest type networks, and determine a corresponding first user in each interest type network, wherein the establishment module includes:

a first acquisition sub-module configured to acquire a user-label matrix according to a label propagation learning algorithm; and

a clustering sub-module configured to cluster the user-label matrix, to obtain a preset number of interest type networks, and acquire a first user in each interest type network.

For example, identity information of the first user includes: user IDs and labels; the interest type network includes labels; and the determination module includes:

a second acquisition sub-module configured to acquire a first label, the first label being a label comprised in the to-be-propagated information; and

a first determination sub-module configured to determine a first user comprising the first label as the first user corresponding to the to-be-propagated information.

For example, the propagation module is further configured to propagate, according to a preset strategy, the information in the user relation network by taking the first user as a starting point, the preset strategy including a propagation range strategy or a propagation speed strategy.

For example, when the preset strategy is the propagation speed strategy, the propagation module includes:

a third acquisition sub-module configured to acquire a propagation probability between users in the user relation network; and

a second determination sub-module configured to determine a path of which the propagation probability is greater than a preset value as a propagation path, and propagate the information according to the propagation path.

For example, wherein the third acquisition sub-module is further configured to acquire the propagation probability between users in the user relation network according to a propagation probability learning model into which a propagation probability variance control factor is introduced.

For example, the third acquisition sub-module includes:

an acquisition unit configured to acquire the user relation network, and establish an information propagation model according to the user relation network and time slice data, the time slice data being preset information propagation and spread time;

a modeling unit configured to introduce a propagation probability variance control factor into a propagation probability learning model, to obtain the propagation probability learning model into which the propagation probability variance control factor is introduced, and learn the information propagation model according to the propagation probability learning model into which the propagation probability variance control factor is introduced, to acquire a propagation probability updating rule, the updating rule comprising a first updating rule and a second updating rule;

an updating unit configured to update a propagation probability between a first group of users by using the first updating rule, and update a propagation probability between a second group of users by using the second updating rule, edges between the first group of users being activated in the time slice data, and edges between the second group of users being not activated in the time slice data; and

a determination unit configured to determine the updated propagation probability between the users as the propagation probability between the users in the user relation network.

Example information propagation methods and apparatuses according to the example embodiments of the present disclosure are described in the following with reference to the accompanying drawings.

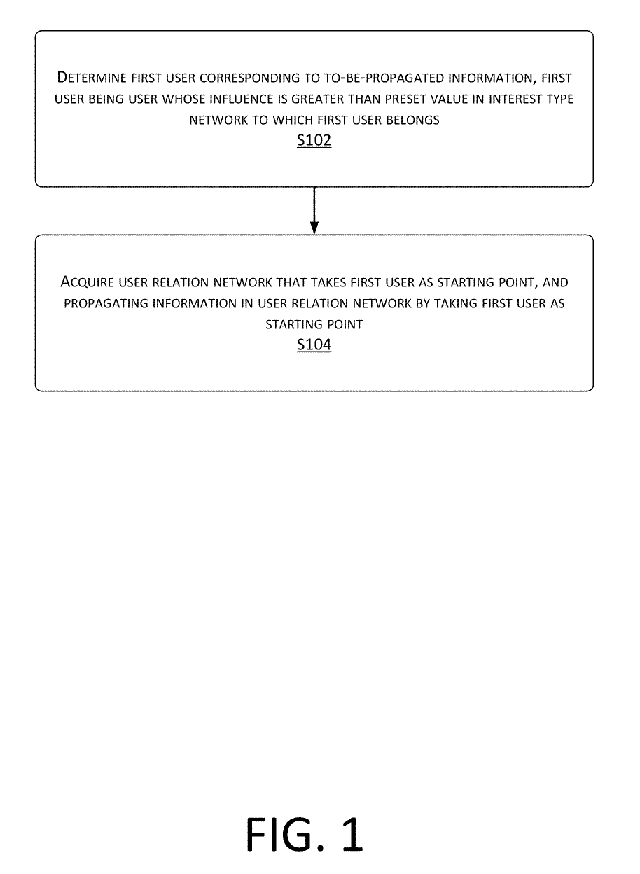

FIG. 1 is a schematic flowchart of an information propagation method according to an example embodiment of the present disclosure. The method includes:

S102: determining a first user corresponding to to-be-propagated information, the first user being a user whose influence is greater than a preset value in an interest type network to which the first user belongs.

Wherein the to-be-propagated information may be commodity promotion information, and may also be other information, to which the present disclosure makes no limitation. There may be one or more first users corresponding to the to-be-propagated information.

The interest type network is the name of a category obtained after users are classified based on interests of the users. The interests of the users may be determined according to labels of the users, and the labels of the users may be pre-determined according to the users' purchase or browsing of historical commodity information and the like.

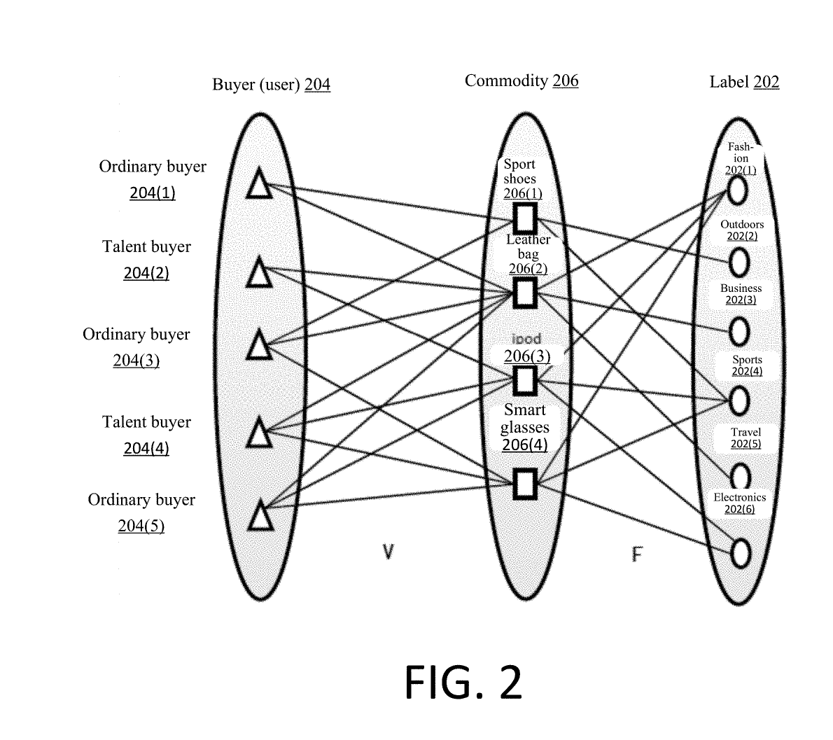

Specifically, it is possible to pre-establish a preset number of interest type networks, and determine a corresponding first user in each interest type network. For example, it is possible to preset multiple labels, and classify users into different interest type networks according to the labels. As shown in FIG. 2, the interest type networks include label 202 such as fashion 202(1), outdoors 202(2), business 202(3), sports 202(4), travel 202(5), and electronics 202(6), and each buyer (user) 204, such as ordinary buyer 204(1), talent buyer 204(2), ordinary buyer 204(3), talent buyer 204(4), and ordinary buyer 204(5), may correspond to one or more labels. Each of the label 202 and the buyer (user) 204 may correspond to one or more commodities 206, such as sport shoes 206(1), leather bag 206(2), ipod 206(3), and smart glasses 206(4).

The first user is a user whose influence is greater than a preset value in an interest type network. The influence is an attribute of the user. In this example embodiment, an influence of a user is used to measure a degree of difficulty that information propagated by the user is accepted by others, wherein information propagated by a user with a greater influence is easier to be accepted by others. The first user may also be referred to as a talent. There may be one or more talents in each interest type network.

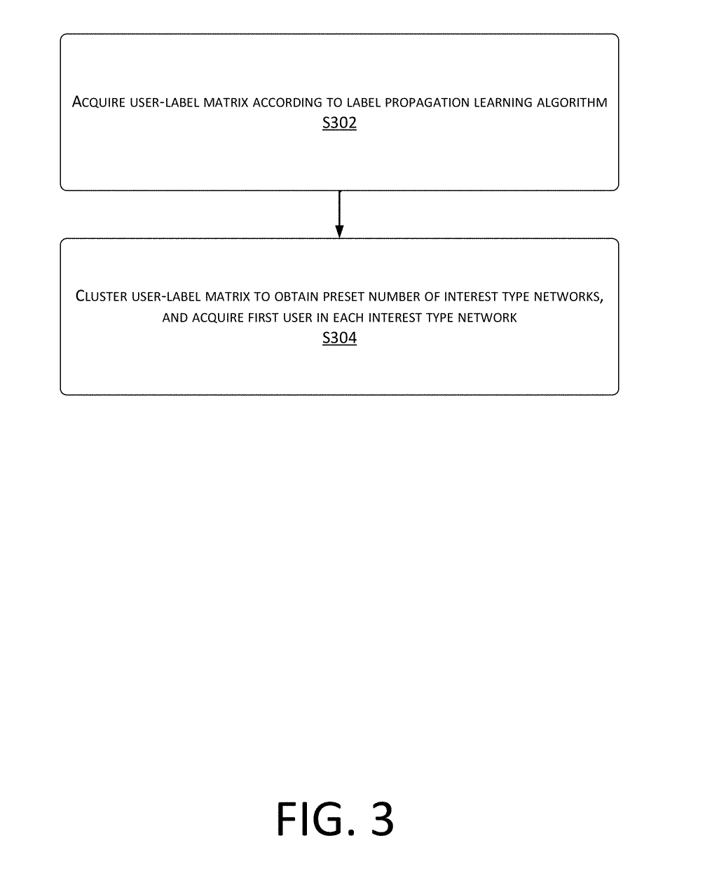

Optionally, by taking that the to-be-propagated information is commodity information as an example, as shown in FIG. 3, the establishing a preset number of interest type networks, and determining a corresponding first user in each interest type network may specifically include:

S302: acquiring a user-label matrix according to a label propagation learning algorithm.

Specifically, the acquiring a user-label matrix according to a label propagation learning algorithm may include:

(1) A Similarity Degree Matrix W Between Commodities is Calculated.

A similarity degree matrix between commodities can be used to indicate a similarity degree between the commodities in terms of user behaviors, commodity titles and commodity attributes.

Wherein commodities for calculating a similarity degree matrix may be commodities processed by superior buyers. The processing may specifically refer to one or more of purchase, browse, click and collecting. The superior buyers may be determined according to a superior buyer model. For example, buyers with a high credit rating or high purchase frequency are determined as superior buyers. Specifically, information of all buyers may be acquired, then superior buyers are determined from all the buyers according to a superior buyer model, commodities processed by the superior buyers are acquired, and a similarity degree is calculated according to every two commodities in the commodities processed by the superior buyers, to obtain a similarity degree matrix W.

Specifically, hash mapping may be performed on commodities (pid, vid) through a minimum hash algorithm, to obtain a similarity degree matrix between the commodities, wherein pid denotes an Identity (ID) of a commodity, vid denotes an ID of a commodity attribute value, and pid and vid may generally be acquired from a basic data table.

(2) A Commodity-Label Information Matrix F is Calculated.

Wherein commodities in the commodity-label information matrix F may also specifically refer to commodities processed by superior buyers, and labels refer to labels after the commodities are updated. After the commodities processed by the superior buyers are acquired, the commodity-label information matrix F may be calculated according to an initial label of each commodity through an iteration process, wherein the initial label of each commodity may be pre-recorded in a database as an attribute of the commodity, and thus the initial label of the commodity can be acquired from the database.

Specifically, the commodity-label information matrix F may be obtained according to an iterative formula of a label propagation learning algorithm, wherein the iterative formula is as follows:

While (F converge)

F(t+1)=αSF(t)+(1−α)Y

end

wherein in the above formula, when the commodity-label information matrix F to be calculated converges, F(t+1) is obtained, 0≦α≦1 is a preset weighting parameter, S is calculated according to the similarity degree matrix W between the commodities, S=D⁻¹W∈R^{n×n}, S=diag{D₁₁, . . . , Dₙₙ}∈Rn^{n×n},

$${D}_{s} = {\sum }_{i = 1}^{n} {W}_{ij} = {\sum }_{j = 1}^{n} {W}_{ji} ,$$

Y is an initial label value, an initial value of F(t) may be an initial value of the commodity-label information matrix F obtained according to existing buyer information, and the existing buyer information may be obtained according to a superior buyer model. For example, a preset number of superior buyers are determined from multiple buyers according to credit ratings of the buyers, then a user-commodity information matrix V may be obtained according to the superior buyers and commodities purchased, clicked or collected corresponding to the superior buyers, and the initial value of the commodity-label information matrix F may be obtained according to the commodities purchased, clicked or collected by the superior buyers and labels of the commodities.

Wherein, the labels of the commodities may be obtained according to statistics or a Hyperlink-Induced Topic Search (HITS) sorting algorithm.

After the initial value of F is acquired, the commodity-label information matrix F may be finally obtained according to the iterative formula when an iterative convergence condition is satisfied.

The iterative convergence condition may include: setting a maximum number of iterations, and the iterative convergence condition is satisfied when the number of iterations reaches the maximum number of iterations; or according to a difference between a value after iteration and a value before iteration, the iterative convergence condition is satisfied when the difference is greater than a preset threshold. For example, when ∥F(t+1)−F(t)∥<β, it indicates that the iterative convergence condition is satisfied, wherein ∥F(t+1)−F(t)∥ denotes an Euclidean distance between F(t+1) and F(t), and β denotes the preset threshold.

(3) A User-Label Matrix L is Calculated.

Wherein users in the user-label matrix L may also specifically refer to superior buyers, labels refer to labels of the users, and the labels of the users may be determined according to updated labels of commodities processed by the users.

Specifically, it is possible to determine superior buyers in the manner as illustrated above, acquire commodities processed by the superior buyers, and acquire initial labels of the commodities processed by the superior buyers from a database. Then, a similarity degree matrix W between commodities may be calculated according to the commodities processed by the superior buyers and the above formula (1), then a commodity-label information matrix F may be calculated according to the similarity degree matrix W between commodities and the initial labels of the commodities processed by the superior buyers as well as the above formula (2), and a user-commodity information matrix V may be established according to the superior buyers and the commodities processed by the superior buyers. Afterwards, a user-label matrix L is obtained according to the above V and F in a manner as follows.

Specifically, a calculation formula may be: L=V*F, wherein V is the user-commodity information matrix obtained above, and F is the final commodity-label information matrix obtained during convergence.

S304: clustering the user-label matrix, to obtain a preset number of interest type networks, and acquiring a first user in each interest type network.

After the user-label matrix L is obtained, the matrix L may be clustered. For example, if a preset number is k, the matrix L may be bi-clustered to obtain k categories, and each category corresponds to one interest type network.

After the matrix L is clustered to obtain k categories, by taking that each interest type network includes one first user as an example, a central point of each category may be determined as the first user of the interest type network. First users of different interest type networks may make up a list, and the list may be referred to as a list of talents. The list of talents, for example, is expressed as: P={p₁, p₂, . . . , pₖ}, wherein pᵢ (i=1, 2, . . . , k) is the first user in the i^{th} interest type network, and may also be referred to as a talent, and pᵢ may be made up of a user ID and a label of the user.

After multiple interest type networks are pre-established and a first user in each interest type network is determined, as stated above, a list of talents made up of first users in different interest type networks may be obtained. The list of talents includes first users in different interest type networks, and when information needs to propagated currently, a first user corresponding to the to-be-propagated information may be determined at first.

Optionally, the determining a first user corresponding to to-be-propagated information includes:

acquiring a first label, the first label being a label included in the to-be-propagated information; and

determining a first user including the first label as the first user corresponding to the to-be-propagated information.

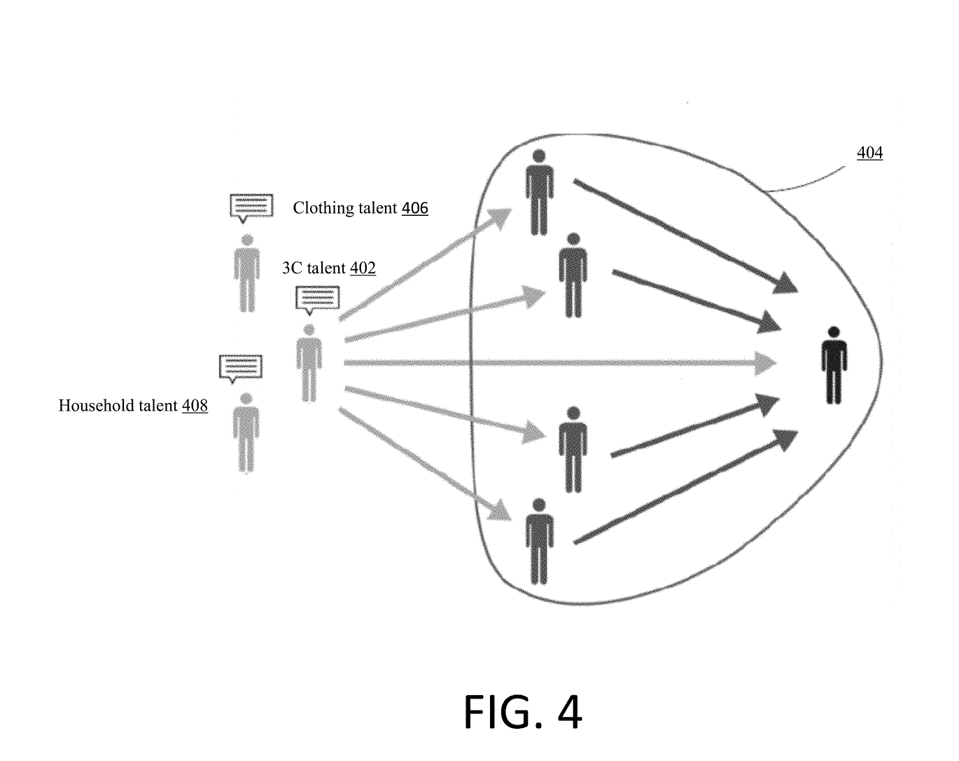

For example, suppose that the first user is referred to as a talent, as shown in FIG. 4, the list of talents includes: clothing talents, 3C talents, and household talents. Then, if a label included in the to-be-propagated information is 3C, the first user corresponding to the to-be-propagated information is a 3C talent.

S104: acquiring a user relation network that takes the first user as a starting point, and propagating the information in the user relation network by taking the first user as a starting point.

Wherein, the user relation network is a network for describing an association relationship between users. The user relation network may be acquired directly from an existing social network-type application. In the social network-type application, the users may pre-establish a user relation network in a manner such as adding a friend or increasing follows. For example, it is possible to first acquire, from an application of the first user, that friends of the first user include a second user and then acquire, from an application of the second user, that friends of the second user include a third user. Therefore, the user relation network that can be acquired includes: a first user→a second user→a third user.

The user relation network that takes the first user as a starting point may be imported from existing data of an application, for example, the user relation network that takes the determined first user as a starting point is imported from an application of a social network.

For example, as shown in FIG. 4, suppose that the first user corresponding to the to-be-propagated information is a 3C talent 402, and the user relation network that takes the 3C talent 402 as a starting point acquired from existing data is a user relation network 404, and then, as shown in FIG. 4, the to-be-propagated information may be propagated in the user relation network 404 by taking the 3C talent 402 as a starting point. Some other user relation networks may start from a clothing talent 406 or a household talent 408 respectively.

Optionally, the propagating the information in the user relation network by taking the first user as a starting point includes:

propagating, according to a preset strategy, the information in the user relation network by taking the first user as a starting point, the preset strategy including a propagation range strategy, or a propagation speed strategy.

Wherein the propagation range strategy refers to giving priority to a propagation range, and the propagation speed strategy refers to giving priority to a propagation speed.

Specifically, a propagation probability between users in the user relation network may be acquired. When the propagation range strategy is adopted, information propagation may be performed regardless of the propagation probability. When the propagation speed strategy is adopted, information propagation may be performed only on a path of which the propagation probability is greater than a preset value.

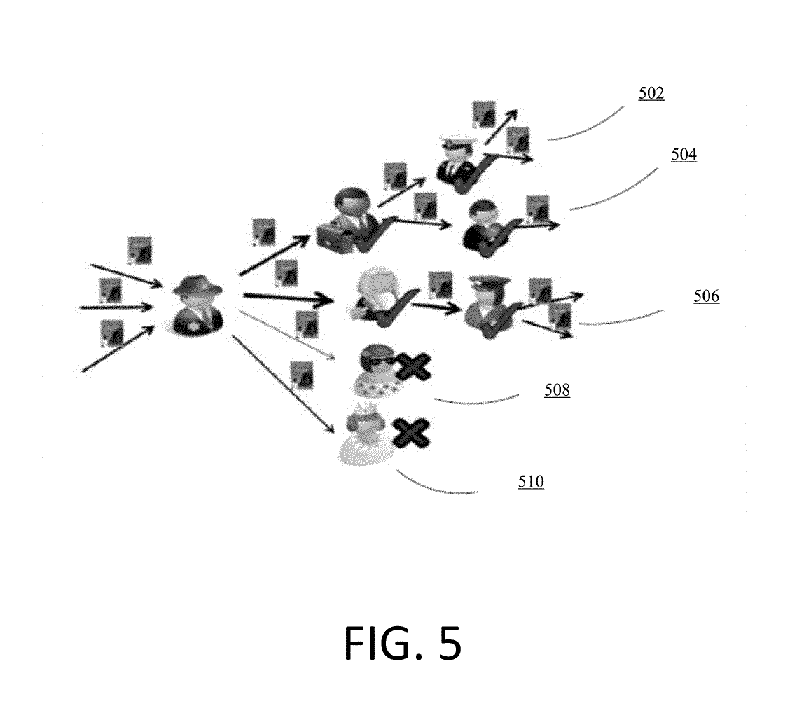

For example, by taking the propagation speed strategy as an example, referring to FIG. 5, suppose that the user relation network includes a first path 502, a second path 504, a third path 506, a fourth path 508, and a fifth path 510, and suppose that propagation probabilities between users included in the first path 502, the second path 504, and the third path 506 are all greater than a preset value and that there are propagation probabilities, which are less than the preset value, between users on the fourth path 508 and the fifth path 510, and therefore, information may be propagated on the first path 502, the second path 504, and the third path 506, but not propagated on the fourth path 508 and the fifth path 510.

Specifically, when the information is propagated in the user relation network, the first user is used as a seed node of information propagation at an initial moment. The seed node is responsible for propagating information to its neighbor nodes. For example, the first user is a 3C talent, and neighbor nodes adjacent to the 3C talent include a first node and a second node. Then, at an initial moment t, the 3C talent is set as a seed node, and the 3C talent propagates information to the first node and the second node. After the seed node propagates information to a neighbor node, the neighbor node becomes a new seed node at next moment. For example, at a t+1 moment, the seed node is the first node rather than the 3C talent. The rest can be done in the same manner, and information propagation is performed sequentially according to user neighboring relations in the user relation network from the initial first user, until there is no new seed node. In addition, propagation probabilities between users of the neighbor nodes in the user relation network are independent of each other, and are not affected by relations between other neighbor nodes. Moreover, each seed node only has one chance to propagate information to a non-seed neighbor node. For example, a user becomes a seed node at a t moment and only has one chance to attempt to propagate information to a non-seed neighbor node at the t moment. If propagation is successful, the neighbor node becomes a seed node at a t+1 moment, and regardless of whether the user successfully propagates the information at the t moment, the user cannot attempt to propagate the information to its neighbor nodes at other moments any more. If multiple seed nodes attempt to propagate the information to the same node at a same moment, the propagation order may be arbitrary.

Optionally, the acquiring a propagation probability between users in the user relation network includes:

acquiring the propagation probability between users in the user relation network according to a propagation probability learning model into which a propagation probability variance control factor is introduced.

For example, the propagation probability learning model may be an EM model. Owing to sparseness of data, in a process of propagation probability learning, a propagation probability learned according to the EM model often has a relatively great variance. This is mainly because that an EM model calculation method overfits in the case of sparse data, resulting in non-uniform data distribution, and it is easy to estimate and obtain an extreme probability situation where the probability is 0 or 1.

In the example embodiments of the present disclosure, in order to solve the above problem existing in the traditional EM model, a propagation probability variance control factor is introduced into the EM model, to prevent the EM model from fluctuating violently in an iteration process.

Optionally, the acquiring the propagation probability between users in the user relation network according to a propagation probability learning model into which a propagation probability variance control factor is introduced includes:

acquiring the user relation network, and establishing an information propagation model according to the user relation network and time slice data, the time slice data being preset information propagation and spread time;

introducing a propagation probability variance control factor into a propagation probability learning model, to obtain the propagation probability learning model into which the propagation probability variance control factor is introduced, and learning the information propagation model according to the propagation probability learning model into which the propagation probability variance control factor is introduced, to acquire a propagation probability updating rule, the updating rule including a first updating rule and a second updating rule;

updating a propagation probability between a first group of users by using the first updating rule, and updating a propagation probability between a second group of users by using the second updating rule, edges between the first group of users being activated in the time slice data, and edges between the second group of users being not activated in the time slice data; and

determining the updated propagation probability between the users as the propagation probability between the users in the user relation network.

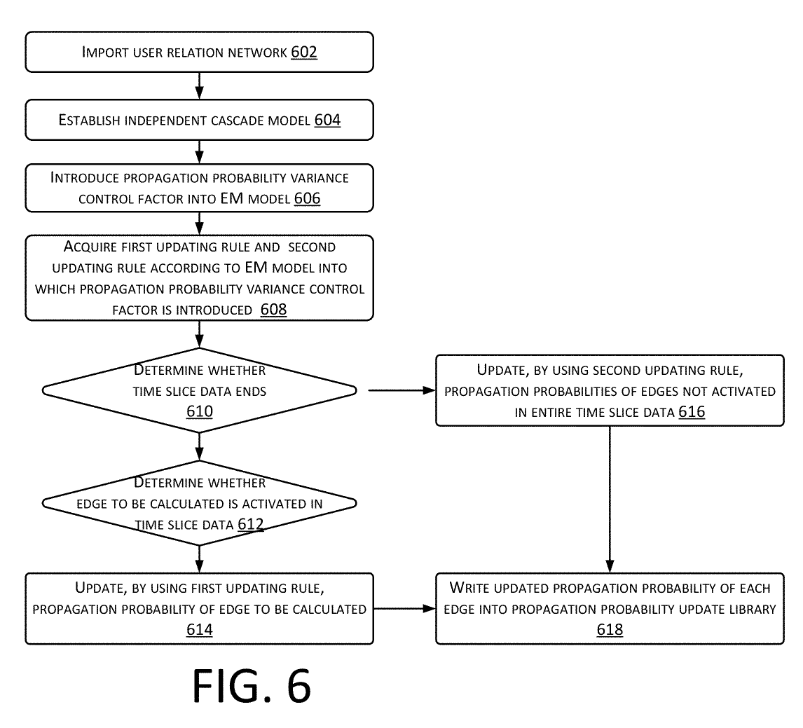

Specifically, as shown in FIG. 6, the process of acquiring the propagation probability between users may include:

602: importing a user relation network.

For example, the user relation network is imported from an application of an existing social network.

604: establishing an independent cascade model.

The independent cascade model is a basic propagation model, and may be established according to a user relation network by using the existing manner.

The propagation model may include nodes and edges, wherein each node may correspond to one user in the user relation network, and each edge is a line segment made up of two adjacent users in the user relation network.

606: introducing a propagation probability variance control factor into an EM model.

The EM model is an optimization algorithm. In this example embodiment, the EM model may be adopted to learn the independent cascade model, so as to obtain a propagation probability of each edge included in the independent cascade model, that is, the propagation probability between the users in the user relation network.

The traditional EM model may be expressed as:

$$L ( θ ) = {\sum }_{s = 1}^{S} log L ( q \vert {D}_{s} ) = {\sum }_{s = 1}^{S} {\sum }_{t = 0}^{T - 1} [ {\sum }_{w ∈ Ds ( t + 1 )} log {P}_{w}^{s} + {\sum }_{v ∈ Ds ( t )} {\sum }_{w ∈ Fv \backslash C ( t + 1 )} log ( 1 - {k}_{v , w} ) ]$$

After the propagation probability variance control factor is introduced, different EM models into which the propagation probability variance control factor is introduced may be obtained according to whether a solving process converges, and which EM model into which the propagation probability variance control factor is introduced is adopted may be determined according to actual needs. Specifically, the EM model into which the propagation probability variance control factor is introduced may be:

$${L}_{λ} ( θ ) = ( 1 - λ ) L ( θ ) - \frac{λ}{m} \sum {[ {θ}_{i} - E ( {θ}_{i} ) ]}^{2}$$

$$or$$

$${L}_{λ} ( θ ) = ( 1 - λ ) L ( θ ) - \frac{λ}{m} \sum \vert log {θ}_{i} - E ( log {θ}_{i} ) \vert$$

wherein λ is a control factor, and is a propagation probability of the edge (v, w).

608: acquiring a first updating rule and a second updating rule according to the EM model into which the propagation probability variance control factor is introduced.

Wherein an optimization equation may be determined first according to the EM model into which λ is introduced, and then the optimization equation is solved, to obtain the first updating rule.

Specifically, if the EM model into which λ is introduced is:

$${L}_{λ} ( θ ) = ( 1 - λ ) L ( θ ) - \frac{λ}{m} \sum {[ {θ}_{i} - E ( {θ}_{i} ) ]}^{2}$$

and an optimization equation corresponding thereto is:

$${Q}_{λ} ( θ \vert θ ) = ( 1 - λ ) {\sum }_{s = 1}^{S} {\sum }_{t = 0}^{T - 1} {\sum }_{v ∈ {D}_{s} ( t )} ( {\sum }_{w ∈ F ( v ) ⋂ {D}_{s} ( t + 1 )} ( \frac{{\hat{k}}_{v , w}}{{\hat{P}}_{w} ( s )} \frac{1}{{k}_{v , w }} + ( 1 - \frac{{\hat{k}}_{v , w}}{{\hat{P}}_{w} ( s )} ) \frac{1}{{k}_{v , w} - 1} ) + {\sum }_{w ∈ F ( v ) / C ( t + 1 )} \frac{1}{{k}_{v , w} - 1} ) - \frac{2 λ}{m} {\sum }_{( v , w ) ∈ E} ( {k}_{v , w} - E ( {\hat{k}}_{v , w} ) ) = 0$$

then, the first updating rule obtained after the optimization equation is solved is:

$${k}_{v , w} = ( 1 - λ ) \frac{1}{\vert {S}_{v , w}^{+} \vert + \vert {S}_{v , w}^{-} \vert} {\sum }_{s ∈ {S}_{v , w}^{+}} \frac{{\hat{k}}_{v , w}}{{\hat{P}}_{w} ( s )} + λ E ( {\hat{k}}_{v , w} )$$

wherein |s_{v,w}⁺| denotes v∈Dₛ(t), w∈D_{z}(t+1), |s_{v,w}⁻| denotes v∈Dₛ(t), w∉Dₛ(t+1), Dₛ(t) denotes a set of points activated at a t moment, and P_{w}(s) denotes a probability that w is activated.

The second updating rule obtained after the optimization equation is solved is:

$$- \frac{2 λ}{m} {\sum }_{( v , w ) ∈ E} ( {k}_{v , w} - E ( {\hat{k}}_{v , w} ) ) = 0$$

to obtain

k_{v,w}=E(\hat{k}_{v,w})

If the EM model into which λ is introduced is:

$${L}_{λ} ( θ ) = ( 1 - λ ) L ( θ ) - \frac{λ}{m} \sum \vert log ( {θ}_{i} ) - E ( log ( {θ}_{i} ) ) \vert$$

and an optimization equation corresponding thereto is:

$${Q}_{λ} ( θ \vert θ ) = ( 1 - λ ) {\sum }_{s = 1}^{S} {\sum }_{t = 0}^{T - 1} {\sum }_{v ∈ {D}_{s} ( t )} ( {\sum }_{w ∈ F ( v ) ⋂ {D}_{s} ( t + 1 )} ( \begin{matrix}\frac{{\hat{k}}_{v , w}}{{\hat{P}}_{w} ( s )} log {k}_{v , w} + \\ ( 1 - \frac{{\hat{k}}_{v , w}}{{\hat{P}}_{w} ( s )} ) log ( 1 - {k}_{v , w} )\end{matrix} ) + {\sum }_{w ∈ F ( v ) / C ( i + 1 )} log ( 1 - {k}_{v , w} ) ) - \frac{λ}{m} {\sum }_{( v , w ) ∈ E} \vert log {k}_{v , w} - E ( log {\hat{k}}_{v , w} ) \vert$$

then, the first updating rule obtained after the optimization equation is solved is:

$${k}_{v , w} = \{ \begin{matrix}\frac{( 1 - λ ) {\sum }_{a ∈ {s}_{v , w}^{+}} \frac{{\hat{k}}_{v , w}}{{\hat{P}}_{w} ( a )} - \frac{λ}{m}}{( 1 - λ ) ( \vert {S}_{v , w}^{+} \vert + \vert {S}_{v , w}^{-} \vert ) - \frac{λ}{m}} & if {\hat{k}}_{v , w} \geq {( {\prod }_{( p , q ) ∈ E} {\hat{k}}_{p , q} )}^{1 / \vert E \vert} \\ \frac{( 1 - λ ) {\sum }_{a ∈ {S}_{v , w}^{+}} \frac{{\hat{k}}_{v , w}}{{\hat{P}}_{w} ( a )} + \frac{λ}{m}}{( 1 - λ ) ( \vert {S}_{v , w}^{+} \vert + \vert {S}_{v , w}^{-} \vert ) + \frac{λ}{m}} & if {\hat{k}}_{v , w} < {( {\prod }_{( p , q ) ∈ E} {\hat{k}}_{p , q} )}^{1 / \vert E \vert}\end{matrix}$$

and the second updating rule obtained after the optimization equation is solved is:

$${k}_{v , w} = {( {\prod }_{( p , q ) ∈ E} {\hat{k}}_{p , q} )}^{1 / \vert E \vert}$$

610: judging whether time slice data ends, if no, performing 612, and if yes, performing 616.

Wherein the time slice data is preset, for indicating information propagation and spread time.

After the first updating rule and the second updating rule are obtained, a seed node may be selected from the user relation network, and then preset information is propagated according to the user relation network by taking the seed node as a starting point. The propagation time is the preset time slice data.

Specifically, a difference between current time and the time when information propagation begins may be obtained, and if the difference is less than the preset time slice data, it is determined that the time slice data does not end; otherwise, it is determined that the time slice data ends.

612: judging whether an edge to be calculated is activated in the time slice data, and if yes, performing 614; otherwise, repeating 610 and the subsequent steps.

For example, the edge to be calculated is an edge formed by a user A and a user B. Within the information propagation time, the propagated information passes through the user A and the user B, and then it can be determined that the edge formed by the user A and the user B is activated within the time; otherwise, the edge is not activated.

614: updating the propagation probability of the edge to be calculated by using the first updating rule, and then performing 618.

Wherein reference may be made to the above description for the specific formula of the first updating rule.

In addition, each edge may be provided with an initial propagation probability.

616: updating propagation probabilities of edges not activated in the entire time slice data by using the second updating rule, and then performing S618.

For example, in the entire preset time slice data, all edges formed by a user A and a user C are not activated, that is, the information is not propagated between the user A and the user C, and then propagation probabilities of the edges formed by the user A and the user C can be updated by using the second updating rule illustrated above.

618: writing the updated propagation probability of each edge into a propagation probability update library.

It may be understood that the above description takes that the propagation probability learning model is an EM model as an example, and the propagation probability learning model may also be another model, for example, a Markov model.

In this example embodiment, by determining a first user corresponding to to-be-propagated information, the first user being a user whose influence is greater than a preset value, and propagating the information by taking the first user as a starting point, the information can be propagated by the user having a greater influence, thus improving credibility of information propagation and improving efficiency of the information propagation. This example embodiment can determine the first user through a label propagation learning algorithm, thus improving the effectiveness. This example embodiment introduces the control factor into the propagation probability learning model, thus improving the accuracy of propagation probability. This example embodiment can implement diversified propagation of information by setting different propagation strategies.

In order to implement the above example embodiment, the present disclosure further provides an information propagation apparatus.

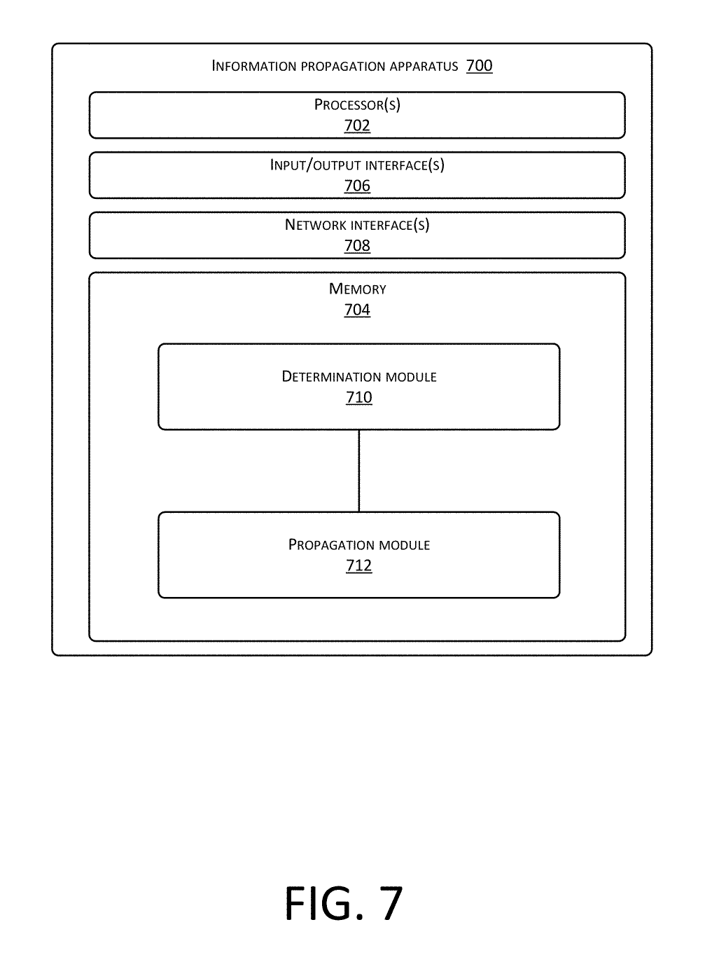

FIG. 7 is a schematic structural diagram of an information propagation apparatus 700 according to another example embodiment of the present disclosure. As shown in FIG. 7, the information propagation apparatus 700 includes one or more processor(s) 702 or data processing unit(s) and memory 704. The information propagation apparatus 700 may further include one or more input/output interface(s) 706 and one or more network interface(s) 708. The memory 704 is an example of computer readable media.

The computer readable media include non-volatile and volatile media as well as movable and non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission media, and can be used to store information accessible to the computing device. According to the definition herein, the computer readable media do not include transitory media, such as modulated data signals and carriers.

The memory 704 may store therein a plurality of modules or units including: a determination module 710 and a propagation module 712.

Specifically, the determination module 710 is configured to determine a first user corresponding to to-be-propagated information, the first user being a user whose influence is greater than a preset value in an interest type network to which the first user belongs. Wherein the to-be-propagated information may be commodity promotion information, and may also be other information, to which the present disclosure makes no limitation. There may be one or more first users corresponding to the to-be-propagated information.

The interest type network may be a network for classifying and labeling users or information according to interest types, and may also be referred to as an interest network.

Specifically, it is possible to pre-establish a preset number of interest type networks, and determine a corresponding first user in each interest type network. For example, it is possible to preset multiple labels, and classify users into different interest type networks according to the labels. As shown in FIG. 2, the interest type networks include labels such as fashion, outdoors, business, sports, travel, and electronics, and each user may correspond to one or more labels. The process of specifically establishing an interest type network will be introduced in the subsequent example embodiment.

The first user is a user whose influence is greater than a preset value in an interest type network. The influence is an attribute of the user. In this example embodiment, an influence of a user is used to measure a degree of difficulty that information propagated by the user is accepted by others, wherein information propagated by a user with a greater influence is easier to be accepted by others.

The first user may also be referred to as a talent. There may be one or more talents in each interest type network.

For example, suppose that the first user is referred to as a talent, as shown in FIG. 4, the list of talents includes: clothing talents, 3C talents and household talents. Then, if a label included in the to-be-propagated information is 3C, the first user corresponding to the to-be-propagated information is a 3C talent.

The propagation module 712 is configured to acquire a user relation network that takes the first user as a starting point, and propagate the information in the user relation network by taking the first user as a starting point. Wherein, the user relation network is a network for describing an association relationship between users. The user relation network may be acquired directly from an existing social network-type application. In the social network-type application, the users may pre-establish a user relation network in a manner such as adding a friend or increasing follows. For example, it is possible to first acquire, from an application of the first user, that friends of the first user include a second user and then acquire, from an application of the second user, that friends of the second user include a third user. Therefore, the user relation network that can be acquired includes: a first user→a second user→a third user.

The user relation network that takes the first user as a starting point may be imported from existing data of an application, for example, the user relation network that takes the determined first user as a starting point is imported from an application of a social network.

For example, as shown in FIG. 4, suppose that the first user corresponding to the to-be-propagated information is a 3C talent, and the user relation network that takes the 3C talent as a starting point acquired from existing data is a user relation network 41, and then, as shown in FIG. 4, the to-be-propagated information may be propagated in the user relation network 41 by taking the 3C talent as a starting point.

In this example embodiment, by determining a first user corresponding to to-be-propagated information, the first user being a user whose influence is greater than a preset value, and propagating the information by taking the first user as a starting point, the information can be propagated by the user having a greater influence, thus improving credibility of information propagation and improving efficiency of the information propagation.

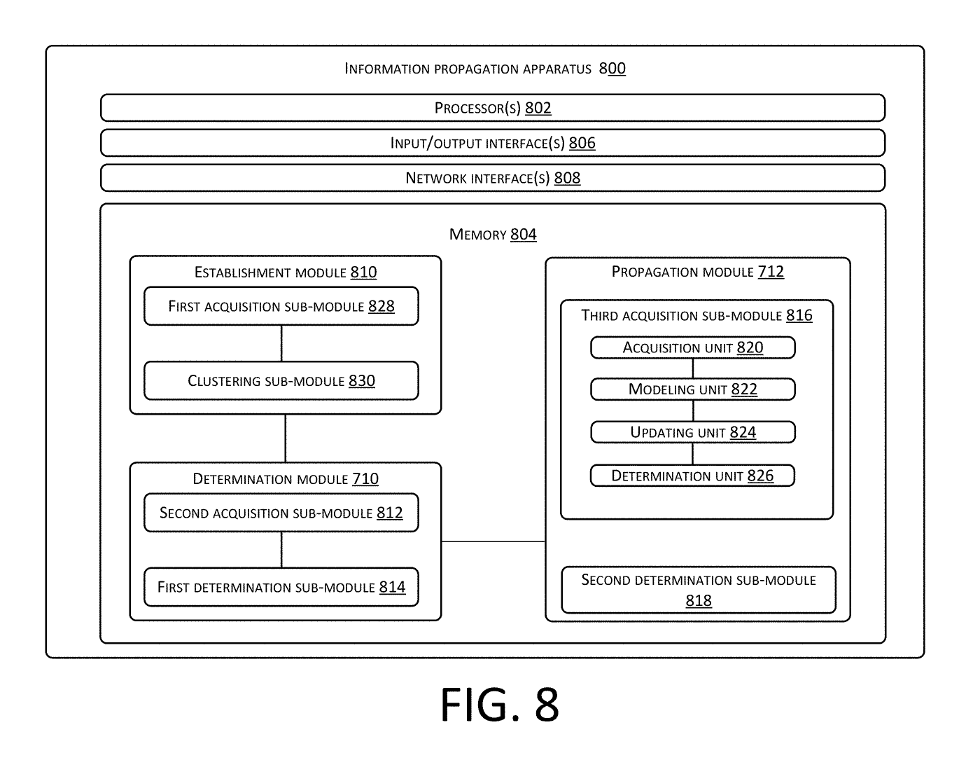

FIG. 8 is a schematic structural diagram of an information propagation apparatus 800 according to another example embodiment of the present disclosure. As shown in FIG. 8, the information propagation apparatus 800 includes one or more processor(s) 802 or data processing unit(s) and memory 804. The information propagation apparatus 800 may further include one or more input/output interface(s) 806 and one or more network interface(s) 808. The memory 804 is an example of computer readable media.

The memory 804 may store therein a plurality of modules or units including: a determination module 710, a propagation module 712, and an establishment module 810.

As shown in FIG. 8, the determination module 710 includes a second acquisition sub-module 812 and a first determination sub-module 814. The propagation module 712 includes a third acquisition sub-module 816 and a second determination sub-module 818. The third acquisition sub-module 816 includes an acquisition unit 820, a modeling unit 822, an updating unit 824, and a determination unit 826. The establishment module 810 includes a first acquisition sub-module 828, and a clustering sub-module 830.

Specifically, the establishment module 810 is configured to establish a preset number of interest type networks, and determine a corresponding first user in each interest type network. By taking that the to-be-propagated information is commodity information as an example, the establishment module 810 may specifically include:

a first acquisition sub-module 828 configured to acquire a user-label matrix according to a label propagation learning algorithm, which may specifically include:

(1) A Similarity Degree Matrix W Between Commodities is Calculated.

A similarity degree matrix between commodities can be used to indicate a similarity degree between the commodities in terms of user behaviors, commodity titles and commodity attributes.

Wherein commodities for calculating a similarity degree matrix may be commodities processed by superior buyers. The processing may specifically refer to one or more of purchase, browse, click and collecting. The superior buyers may be determined according to a superior buyer model. For example, buyers with a high credit rating or high purchase frequency are determined as superior buyers. Specifically, information of all buyers may be acquired, then superior buyers are determined from all the buyers according to a superior buyer model, commodities processed by the superior buyers are acquired, and a similarity degree is calculated according to every two commodities in the commodities processed by the superior buyers, to obtain a similarity degree matrix W.

Specifically, the first acquisition sub-module 828 may perform hash mapping on commodities (pid, vid) through a minimum hash algorithm, to obtain a similarity degree matrix between the commodities, wherein pid denotes an Identity (ID) of a commodity, vid denotes an ID of a commodity attribute value, and pid and vid may be generally acquired from a basic data table.

(2) A Commodity-Label Information Matrix F is Calculated.

Wherein commodities in the commodity-label information matrix F may also specifically refer to commodities processed by superior buyers, and labels refer to labels after the commodities are updated. After the commodities processed by the superior buyers are acquired, the commodity-label information matrix F may be calculated according to an initial label of each commodity through an iteration process, wherein the initial label of each commodity may be pre-recorded in a database as an attribute of the commodity, and thus the initial label of the commodity can be acquired from the database.

Specifically, the commodity-label information matrix F may be obtained according to an iterative formula of a label propagation learning algorithm, wherein the iterative formula is as follows:

While (F converge)

F(t+1)=αSF(t)+(1−α)Y

end

wherein in the above formula, when the commodity-label information matrix F to be calculated converges, F(t+1) is obtained, 0≦α≦1 is a preset weighting parameter, S is calculated according to the similarity degree matrix W between the commodities, S=D⁻¹W∈R^{n×n}, S=diag{D₁₁, . . . , Dₙₙ}∈Rn^{n×n},

$${D}_{s} = {\sum }_{i = 1}^{n} {W}_{ij} = {\sum }_{j = 1}^{n} {W}_{ji} ,$$

Y is an initial label value, an initial value of F(t) may be an initial value of the commodity-label information matrix F obtained according to existing buyer information, and the existing buyer information may be obtained according to a superior buyer model. For example, a preset number of superior buyers are determined from multiple buyers according to credit ratings of the buyers, then a user-commodity information matrix V may be obtained according to the superior buyers and commodities purchased, clicked or collected corresponding to the superior buyers, and the initial value of the commodity-label information matrix F may be obtained according to the commodities purchased, clicked or collected by the superior buyers and labels of the commodities.

Wherein, the labels of the commodities may be obtained according to statistics or a Hyperlink-Induced Topic Search (HITS) sorting algorithm.

After the initial value of F is acquired, the commodity-label information matrix F may be finally obtained according to the iterative formula when an iterative convergence condition is satisfied.

The iterative convergence condition may include: setting a maximum number of iterations, and the iterative convergence condition is satisfied when the number of iterations reaches the maximum number of iterations; or according to a difference between a value after iteration and a value before iteration, the iterative convergence condition is satisfied when the difference is greater than a preset threshold. For example, when ∥F(t+1)−F(t)∥<β, it indicates that the iterative convergence condition is satisfied, wherein ∥F(t+1)−F(t)∥ denotes an Euclidean distance between F(t+1) and F(t), and β denotes the preset threshold.

(3) A User-Label Matrix L is Calculated.

Wherein users in the user-label matrix L may also specifically refer to superior buyers, labels refer to labels of the users, and the labels of the users may be determined according to updated labels of commodities processed by the users.

Specifically, it is possible to determine superior buyers in the manner as illustrated above, acquire commodities processed by the superior buyers, and acquire initial labels of the commodities processed by the superior buyers from a database. Then, a similarity degree matrix W between commodities may be calculated according to the commodities processed by the superior buyers and the above formula (1), then a commodity-label information matrix F may be calculated according to the similarity degree matrix W between commodities and the initial labels of the commodities processed by the superior buyers as well as the above formula (2), and a user-commodity information matrix V may be established according to the superior buyers and the commodities processed by the superior buyers. Afterwards, a user-label matrix L is obtained according to the above V and F in a manner as follows.

More specifically, a calculation formula may be: L=V*F, wherein V is the user-commodity information matrix obtained above, and F is the final commodity-label information matrix obtained during convergence.

A clustering sub-module 830 is configured to cluster the user-label matrix, to obtain a preset number of interest type networks, and acquire a first user in each interest type network. After the user-label matrix L is obtained, the matrix L may be clustered. For example, if a preset number is k, the matrix L may be bi-clustered to obtain k categories, and each category corresponds to one interest type network.

After the matrix L is clustered to obtain k categories, by taking that each interest type network includes one first user as an example, a central point of each category may be determined as the first user of the interest type network. First users of different interest type networks may make up a list, and the list may be referred to as a list of talents. The list of talents, for example, is expressed as: P={p₁, p₂, . . . , pₖ}, wherein pᵢ (i=1, 2, . . . , k) is the first user in the i^{th} interest type network, and may also be referred to as a talent, and pᵢ may be made up of a user ID and a label of the user.

After multiple interest type networks are pre-established and a first user in each interest type network is determined, as stated above, a list of talents made up of first users in different interest type networks may be obtained. The list of talents includes first users in different interest type networks, and when information needs to propagated currently, a first user corresponding to the to-be-propagated information may be determined at first.

The determination module 710 specifically includes:

a second acquisition sub-module 812 configured to acquire a first label, the first label being a label included in the to-be-propagated information; and

a first determination sub-module 814 configured to determine a first user including the first label as the first user corresponding to the to-be-propagated information.

For example, suppose that the first user is referred to as a talent, as shown in FIG. 4, the list of talents includes: clothing talents, 3C talents and household talents. Then, if the second acquisition sub-module 812 acquires that a label included in the to-be-propagated information is 3C, the first determination sub-module 814 determines that the first user corresponding to the to-be-propagated information is a 3C talent.

The propagation module 712 is further configured to propagate, according to a preset strategy, the information in the user relation network by taking the first user as a starting point, the preset strategy including a propagation range strategy, or a propagation speed strategy. Wherein the propagation range strategy refers to giving priority to a propagation range, and the propagation speed strategy refers to giving priority to a propagation speed.

More specifically, the third acquisition sub-module 816 may acquire a propagation probability between users in the user relation network. When the propagation range strategy is adopted, information propagation may be performed regardless of the propagation probability. When the propagation speed strategy is adopted, information propagation may be performed only on a path of which the propagation probability is greater than a preset value. For example, by taking the propagation speed strategy as an example, referring to FIG. 5, suppose that the user relation network includes a first path 502, a second path 504, a third path 506, a fourth path 508, and a fifth path 510, and suppose that propagation probabilities between users included in the first path 502, the second path 504, and the third path 506 are all greater than a preset value and that there are propagation probabilities, which are less than the preset value, between users on the fourth path 508 and the fifth path 510, and therefore, information may be propagated on the first path 502, the second path 504, and the third path 506, but not propagated on the fourth path 508 and the fifth path 510.

More specifically, when the information is propagated in the user relation network, the first user is used as a seed node of information propagation at an initial moment. The seed node is responsible for propagating information to its neighbor nodes. For example, the first user is a 3C talent, and neighbor nodes adjacent to the 3C talent include a first node and a second node. Then, at an initial moment t, the 3C talent is set as a seed node, and the 3C talent propagates information to the first node and the second node. After the seed node propagates information to a neighbor node, the neighbor node becomes a new seed node at next moment. For example, at a t+1 moment, the seed node is the first node rather than the 3C talent. The rest can be done in the same manner, and information propagation is performed sequentially according to user neighboring relations in the user relation network from the initial first user, until there is no new seed node. In addition, propagation probabilities between users of the neighbor nodes in the user relation network are independent of each other, and are not affected by relations between other neighbor nodes. Moreover, each seed node only has one chance to propagate information to a non-seed neighbor node. For example, a user becomes a seed node at a t moment and only has one chance to attempt to propagate information to a non-seed neighbor node at the t moment. If propagation is successful, the neighbor node becomes a seed node at a t+1 moment, and regardless of whether the user successfully propagates the information at the t moment, the user cannot attempt to propagate the information to its neighbor nodes at other moments any more. If multiple seed nodes attempt to propagate the information to the same node at a same moment, the propagation order may be arbitrary.

Optionally, the third acquisition sub-module 816 is further configured to acquire the propagation probability between users in the user relation network according to a propagation probability learning model into which a propagation probability variance control factor is introduced. For example, the propagation probability learning model may be an EM model. Owing to sparseness of data, in a process of propagation probability learning, a propagation probability learned according to the EM model often has a relatively great variance. This is mainly because that an EM model calculation method overfits in the case of sparse data, resulting in non-uniform data distribution, and it is easy to estimate and obtain an extreme probability situation where the probability is 0 or 1.

In the example embodiments of the present disclosure, in order to solve the above problem existing in the traditional EM model, a propagation probability variance control factor is introduced into the EM model, to prevent the EM model from fluctuating violently in an iteration process.

Optionally, the third acquisition sub-module 816 includes:

an acquisition unit 820, which is configured to acquire the user relation network, for example, import the user relation network from an application of an existing social network, and establish an information propagation model according to the user relation network and time slice data. For example, an independent cascade model may be established. The independent cascade model is a basic propagation model, and may be established according to a user relation network by using the existing manner.

Wherein, the time slice data is preset, for indicating information propagation and spread time.

The propagation model may include nodes and edges, wherein each node may correspond to one user in the user relation network, and each edge is a line segment made up of two adjacent users in the user relation network.

The modeling unit 822 is configured to introduce a propagation probability variance control factor into a propagation probability learning model, to obtain the propagation probability learning model into which the propagation probability variance control factor is introduced, and learn the information propagation model according to the propagation probability learning model into which the propagation probability variance control factor is introduced, to acquire a propagation probability updating rule, the updating rule including a first updating rule and a second updating rule.

The EM model is an optimization algorithm. In this example embodiment, the EM model may be adopted to learn the independent cascade model, so as to obtain a propagation probability of each edge included in the independent cascade model, that is, the propagation probability between the users in the user relation network.

The traditional EM model may be expressed as:

$$L ( θ ) = {\sum }_{v = 1}^{S} log L ( q \vert {D}_{s} ) = {\sum }_{s = 1}^{S} {\sum }_{t = 0}^{T - 1} [ {\sum }_{w ∈ Ds ( t + 1 )} log {P}_{w}^{s} + {\sum }_{v ∈ Ds ( t )} {\sum }_{w ∈ Fv \backslash C ( t + 1 )} log ( 1 - {k}_{v , w} ) ]$$

After the propagation probability variance control factor is introduced, different EM models into which the propagation probability variance control factor is introduced may be obtained according to whether a solving process converges, and which EM model into which the propagation probability variance control factor is introduced is adopted may be determined according to actual needs. Specifically, the EM model into which the propagation probability variance control factor is introduced may be:

$${L}_{λ} ( θ ) = ( 1 - λ ) L ( θ ) - \frac{λ}{m} \sum {[ {θ}_{i} - E ( {θ}_{i} ) ]}^{2}$$

$$or$$

$${L}_{λ} ( θ ) = ( 1 - λ ) L ( θ ) - \frac{λ}{m} \sum \vert log {θ}_{i} - E ( log {θ}_{i} ) \vert$$

wherein λ is a control factor, and is a propagation probability of the edge (v, w).

Wherein an optimization equation may be determined first according to the EM model into which λ is introduced, and then the optimization equation is solved, to obtain the first updating rule.

Specifically, if the EM model into which λ is introduced is:

$${L}_{λ} ( θ ) = ( 1 - λ ) L ( θ ) - \frac{λ}{m} \sum {[ {θ}_{i} - E ( {θ}_{i} ) ]}^{2}$$

and an optimization equation corresponding thereto is:

$${Q}_{λ} ( θ \vert θ ) = ( 1 - λ ) {\sum }_{s = 1}^{S} {\sum }_{v = 0}^{T - 1} {\sum }_{v ∈ {D}_{s} ( t )} ( {\sum }_{w ∈ F ( v ) ⋂ {D}_{s} ( t + 1 )} ( \frac{{\hat{k}}_{v , w}}{{\hat{P}}_{w} ( s )} \frac{1}{{k}_{v , w}} + ( 1 - \frac{{\hat{k}}_{v , w}}{{\hat{P}}_{w} ( s )} ) \frac{1}{{k}_{v , w} - 1} ) + {\sum }_{w ∈ F ( v ) / C ( i + 1 )} \frac{1}{{k}_{v , w} - 1} ) - \frac{2 λ}{m} ( {k}_{v , w} - E ( {\hat{k}}_{v , w} ) ) = 0$$

then, the first updating rule obtained after the optimization equation is solved is:

$${k}_{v , w} = ( 1 - λ ) \frac{1}{\vert {S}_{v , w}^{+} \vert + \vert {S}_{v , w}^{-} \vert} {\sum }_{s ∈ {S}_{v , w}^{+}} \frac{{\hat{k}}_{v , w}}{{\hat{P}}_{w} ( s )} + λ E ( {\hat{k}}_{v , w} )$$

wherein |s_{v,w}⁺| denotes v∈Dₛ(t), w∈D_{z}(t+1), |s_{v,w}⁻| denotes v∈Dₛ(t), w∉Dₛ(t+1), Dₛ(t) denotes a set of points activated at a t moment, and P_{w}(s) denotes a probability that w is activated.

The second updating rule obtained after the optimization equation is solved is:

$$- \frac{2 λ}{m} {\sum }_{( v , w ) ∈ E} ( {k}_{v , w} - E ( {\hat{k}}_{v , w} ) ) = 0$$

to obtain

k_{v,w}=E(\hat{k}_{v,w})

If the EM model into which λ is introduced is:

$${L}_{λ} ( θ ) = ( 1 - λ ) L ( θ ) - \frac{λ}{m} \sum \vert log ( {θ}_{i} ) - E ( log ( {θ}_{i} ) ) \vert$$

and an optimization equation corresponding thereto is:

$${Q}_{λ} ( θ \vert θ ) = ( 1 - λ ) {\sum }_{s = 1}^{S} {\sum }_{t = 0}^{T - 1} {\sum }_{v ∈ {D}_{2} ( t )} ( {\sum }_{w ∈ F ( v ) ⋂ {D}_{s} ( t + 1 )} ( \begin{matrix}\frac{{\hat{k}}_{v , w}}{{\hat{P}}_{w} ( s )} log {k}_{v , w} + \\ ( 1 - \frac{{\hat{k}}_{v , w}}{{\hat{P}}_{w} ( s )} ) log ( 1 - {k}_{v , w} )\end{matrix} ) + {\sum }_{w ∈ F ( v ) / C ( i + 1 )} log ( 1 - {k}_{v , w} ) ) - \frac{λ}{m} {\sum }_{( v , w ) ∈ E} \vert log {k}_{v , w} - E ( log {\hat{k}}_{v , w} ) \vert$$

then, the first updating rule obtained after the optimization equation is solved is:

$${k}_{v , w} = \{ \begin{matrix}\frac{( 1 - λ ) {\sum }_{a ∈ {s}_{v , w}^{+}} \frac{{\hat{k}}_{v , w}}{{\hat{P}}_{w} ( a )} - \frac{λ}{m}}{( 1 - λ ) ( \vert {S}_{v , w}^{+} \vert + \vert {S}_{v , w}^{-} \vert ) - \frac{λ}{m}} & if {\hat{k}}_{v , w} \geq {( {\prod }_{( p , q ) ∈ E} {\hat{k}}_{p , q} )}^{1 / \vert E \vert} \\ \frac{( 1 - λ ) {\sum }_{a ∈ {S}_{v , w}^{+}} \frac{{\hat{k}}_{v , w}}{{\hat{P}}_{w} ( a )} + \frac{λ}{m}}{( 1 - λ ) ( \vert {S}_{v , w}^{+} \vert + \vert {S}_{v , w}^{-} \vert ) + \frac{λ}{m}} & if {\hat{k}}_{v , w} < {( {\prod }_{( p , q ) ∈ E} {\hat{k}}_{p , q} )}^{1 / \vert E \vert}\end{matrix}$$

and the second updating rule obtained after the optimization equation is solved is:

$${k}_{v , w} = {( {\prod }_{( p , q ) ∈ E} {\hat{k}}_{p , q} )}^{1 / \vert E \vert}$$

The updating unit 824 is configured to update a propagation probability between a first group of users by using the first updating rule, and update a propagation probability between a second group of users by using the second updating rule, edges between the first group of users being activated in the time slice data, and edges between the second group of users being not activated in the time slice data. After the first updating rule and the second updating rule are obtained, a seed node may be selected from the user relation network, and then preset information is propagated according to the user relation network by taking the seed node as a starting point. The propagation time is the preset time slice data. More specifically, it can be determined that whether the time slice data ends. For example, a difference between current time and the time when information propagation begins may be obtained, and if the difference is less than the preset time slice data, it is determined that the time slice data does not end; otherwise, it is determined that the time slice data ends.

If the time slice data does not end, it may be judged whether an edge to be calculated is activated in the time slice data. For example, the edge to be calculated is an edge formed by a user A and a user B, within the information propagation time, the propagated information passes through the user A and the user B, and then it can be determined that the edge formed by the user A and the user B is activated within the time; otherwise, the edge is not activated. If the edge is activated, the propagation probability of the edge to be calculated is updated by using the first updating rule, and then the updated propagation probability of each edge is written into a propagation probability update library. If the edge is not activated, the process returns to resume judging whether the time slice data ends.

If the time slice data has ended, propagation probabilities of edges not activated in the entire time slice data are updated by using the second updating rule, and then the updated propagation probability of each edge is written into the propagation probability update library.

It may be understood that the above description takes that the propagation probability learning model is an EM model as an example, and the propagation probability learning model may also be another model, for example, a Markov model.

The determination unit 826 is configured to determine the updated propagation probability between the users as the propagation probability between the users in the user relation network.

The second determination sub-module 818 is configured to determine a path of which the propagation probability is greater than a preset value as a propagation path, and propagate the information according to the propagation path, to achieve a maximum propagation speed.

In this example embodiment, by determining a first user corresponding to to-be-propagated information, the first user being a user whose influence is greater than a preset value, and propagating the information by taking the first user as a starting point, the information can be propagated by the user having a greater influence, thus improving credibility of information propagation and improving efficiency of the information propagation. This example embodiment can determine the first user through a label propagation learning algorithm, thus improving the effectiveness. This example embodiment introduces the control factor into the propagation probability learning model, thus improving the accuracy of propagation probability. This example embodiment can implement diversified propagation of information by setting different propagation strategies.

It should be noted that, in the descriptions of the present disclosure, the terms “first”, “second” and the like are merely for the purpose of description, but cannot be understood as indicating or implying relative importance. In addition, in the descriptions of the present disclosure, “multiple” means two or more unless otherwise indicated.

Any process or method described in the flowcharts or in other manners herein may be understood as indicating a module, fragment or part of code including one or more executable instructions for implementing specific logic functions or process steps, and the scope of example embodiments of the present disclosure includes additional implementation, wherein functions can be implemented not in an order illustrated or discussed, including in a basically simultaneous manner according to the functions involved or in a reverse order, and this should be understood by those skilled in the art of the example embodiments of the present disclosure.

It should be understood that various parts of the present disclosure may be implemented by using hardware, software, firmware or a combination thereof. In the above implementations, multiple steps or methods may be implemented by software or firmware stored in a memory and executed by a suitable instruction executing system. For example, if they are implemented by using hardware, like in another implementation, they may be implemented by using any of the following technologies well-known in the art or a combination thereof: a discrete logic circuit having a logic gate circuit for implementing a logic function on a data signal, a specific integrated circuit having a suitable combined logic gate circuit, a programmable gate array (PGA), a field programmable gate array (FPGA), and the like.

Those of ordinary skill in the art may understand that implementation of all or some of steps carried in the method of the above example embodiment may be completed by a program for instructing relevant hardware, the program may be stored in a computer readable storage medium, and when the program is executed, one of the steps or a combination thereof of the method example embodiment is included.

In addition, functional units in the example embodiments of the present disclosure may be integrated into one processing unit, or each of the units may exist alone physically, or two or more units may be integrated into one module. The integrated module may be implemented in a form of hardware, or may be implemented in a form of a software functional unit. When the integrated module is implemented in the form of a software functional unit and sold or used as an independent product, the integrated module may also be stored in a computer readable storage medium.

The storage medium mentioned above may be a read only memory (ROM), a magnetic disk, an optical disk, or the like.

In the descriptions of the specification, the descriptions about the reference terms “an example embodiment”, “some example embodiments”, “an example”, “a specific example”, “some examples” and the like mean that specific features, structures, materials or characteristics described in combination with the example embodiment(s) or example(s) are included in at least one example embodiment or example of the present disclosure. In the specification, schematic expressions of the above terms do not necessarily refer to the same example embodiment or example. Moreover, the specific features, structures, materials or characteristics described may be combined in a suitable manner in any one or more example embodiments or examples.

Although the example embodiments of the present disclosure have been illustrated and described, it may be understood that the above example embodiments are exemplary and cannot be construed as limitations to the present disclosure. Those of ordinary skill in the art may change, modify, replace and transform the above example embodiments within the scope of the present disclosure.

What is claimed is:

1. A method comprising:
collecting user behaviors of user identifications (IDs) associated with commodities, the user behaviors including recorded purchasing histories of the user IDs associated with the commodities;
calculating similarity degrees between commodities based on similarity degrees between attributes of the commodities;
calculating labels associated with the commodities;
associating the user IDs with the labels based on the user behaviors of the user IDs;
extracting multiple interest type networks from the labels;
determining a respective first user ID from a respective interest type network of the multiple interest type networks, the respective first user ID being a user ID whose influence is greater than a preset value in the respective interest type network to which the first user ID belongs based on user behaviors of the respective first user ID associated with respective commodities relating to the respective interest type network; and
establishing a respective user relation network by using the respective first user ID as a starting point and exploring a social network of the respective first user ID, the respective user relation network including one or more contacts of the respective user ID in the social network.

2. The method of claim 1, further comprising:
determining information associated with the respective interest type network; and
propagating the information in the respective user relation network through the respective first user ID.

3. The method of claim 2, wherein the propagating the information in the respective user relation network through the respective first user ID includes:
propagating the information in the user relation network by using the respective first user ID as the starting point.

4. The method of claim 3, wherein the propagating the information in the user relation network by using the first user ID as the starting point includes:
propagating the information in the respective user relation network by using the first user ID as the starting point according to a propagation range strategy.

5. The method of claim 3, wherein the propagating the information in the user relation network by using the first user ID as the starting point includes:
propagating the information in the respective user relation network by using the first user ID as the starting point according to a propagation speed strategy.

6. The method of claim 5, wherein the propagating the information in the respective user relation network by using the first user ID as the starting point according to the propagation speed strategy includes:
acquiring a propagation probability between user IDs in the respective user relation network;
determining a path of which the propagation probability is greater than a preset value as a propagation path; and
propagating the information according to the propagation path.

7. The method of claim 6, wherein the acquiring the propagation probability between user IDs in the respective user relation network includes:
acquiring the propagation probability between the user IDs in the respective user relation network according to a propagation probability learning model into which a propagation probability variance control factor is introduced.

8. The method of claim 7, wherein the acquiring the propagation probability between the user IDs in the respective user relation network according to the propagation probability learning model into which the propagation probability variance control factor is introduced includes:
establishing an information propagation model according to the respective user relation network and time slice data, the time slice data being preset information propagation and spread time;
introducing the propagation probability variance control factor into the propagation probability learning model, to obtain the propagation probability learning model into which the propagation probability variance control factor is introduced; and
learning the information propagation model according to the propagation probability learning model into which the propagation probability variance control factor is introduced, to acquire a propagation probability updating rule.

9. The method of claim 8, further comprising:
updating a propagation probability between a first group of user IDs by using a first updating rule included in the propagation probability updating rule, edges between the first group of user IDs being activated in the time slice data; and
determining the updated propagation probability between the user IDs as the propagation probability between the user IDs in the respective user relation network.

10. The method of claim 8, further comprising:
updating a propagation probability between a second group of users by using a second updating rule included in the propagation probability updating rule, edges between the second group of users being not activated in the time slice data; and
determining the updated propagation probability between the user IDs as the propagation probability between the user IDs in the respective user relation network.

11. The method of claim 1, wherein the user behaviors of the user IDs associated with the commodities further include recorded online browsing, clicking, or collecting histories of the user IDs associated with the commodities.

12. The method of claim 1, wherein the collecting user behaviors of user IDs associated with commodities includes:
determining multiple user IDs as superior user IDs; and
choosing commodities associated with user behaviors of the superior user IDs.

13. The method of claim 12, wherein the determining multiple user IDs as superior user IDs includes:
selecting the superior user IDs from the multiple user IDs according to credit ratings or purchase frequencies associated with the multiple user IDs.

14. The method of claim 1, wherein the attributes of the commodities include:
the user behaviors of the user IDs of the commodities;
titles of the commodities; or
descriptions of the commodities.

15. An apparatus comprising:
one or more processors; and
one or more memories stored thereon computer readable instructions that, when executed by one or more processors, cause the one or more processors to perform acts comprising:
calculating similarity degrees between commodities based on similarity degrees between attributes of the commodities;
calculating labels associated with the commodities;
associating the user IDs with the labels based on the user behaviors of the user IDs;
extracting multiple interest type networks from the labels; and
determining a respective first user ID from a respective interest type network of the multiple interest type networks.

16. The apparatus of claim 15, wherein the respective first user ID is a user ID whose influence is greater than a preset value in the respective interest type network to which the first user ID belongs based on user behaviors of the respective first user ID associated with respective commodities relating to the respective interest type network.

17. The apparatus of claim 15, wherein the acts further comprise:
determining information associated with the respective interest type network; and
propagating the information in the respective user relation network through the respective first user ID.

18. The apparatus of claim 17, wherein the propagating the information in the respective user relation network through the respective first user ID includes:
propagating the information in the user relation network by using the respective first user ID as a starting point.

19. One or more memories stored thereon computer readable instructions that, when executed by one or more processors, cause the one or more processors to perform acts comprising:
determining a first user identification (ID) according to user behaviors associated with multiple user IDs on one or more shopping websites; and
acquiring a user relation network according to one or more contacts of the first user ID in a social network.

20. The one or more memories of claim 19, wherein the first user is a user whose influence is greater than a preset value in an interest type network to which the first user belongs.
